(19) United States
(12) Patent Application Publication
(10) Pub. No.: US 2026/0290355 A1
(43) Pub. Date: Sep. 24, 2026

(54) INTER-CHANNEL TIME DIFFERENCE ESTIMATION DEVICE AND INTER-CHANNEL TIME DIFFERENCE ESTIMATION METHOD

(71) Applicant: Panasonic Intellectual Property Corporation of America, Torrance, CA (US)

(72) Inventors: Hiroyuki EHARA, Kanagawa (JP); Akira HARADA, Kanagawa (JP)

(73) Assignee: Panasonic Intellectual Property Corporation of America, Torrance, CA (US)

(21) Appl. No.: 19/168,685

(22) PCT Filed: Mar. 4, 2024
(86) PCT No.: PCT/JP2024/008138

§ 371 Date: Sep. 24, 2025

Related U.S. Application Data
(60) Provisional application No. 63/455,287, filed on Mar. 29, 2023.

(30) Foreign Application Priority Data
Dec. 14, 2023 (JP) 2023-211347

(51) Int. Cl. G10L 19/008

(52) U.S. Cl. CPC G10L 19/008

(57) ABSTRACT

This inter-channel time difference estimation device comprises: a first conversion unit that converts an L-channel signal and an R-channel signal in a time domain which constitutes a stereo signal respectively into an L-channel spectrum signal and an R-channel spectrum signal in a frequency domain; a calculation unit that calculates a cross-power spectrum from the L-channel spectrum signal and the R-channel spectrum signal; a second conversion unit that converts the cross-power spectrum into an inter-channel cross-correlation function in the time domain; a time domain weighting unit that weights the inter-channel cross-correlation function in accordance with an inter-channel level difference (ILD) value for the stereo signal; and an estimation unit that estimates an inter-channel time difference (ITD) value for the stereo signal on the basis of the weighted inter-channel cross-correlation function.

### TECHNICAL FIELD

The present disclosure relates to an inter-channel time difference estimation apparatus and an inter-channel time difference estimation method.

### BACKGROUND ART

There is an encoding technique for a stereo speech/audio signal (hereinafter may also be referred to as a stereo signal), for example (see, for example, Patent Literature (hereinafter, referred to as “PTL”) 1).

### CITATION LIST

### Patent Literature

### PTL 1

Japanese Patent Application Laid-Open No. 2023-36893

### PTL 2

U.S. Pat. No. 11,594,231

### Non-Patent Literature

### NPL 1

Charles H. Knapp and G. Clifford Carter, “The Generalized Correlation Method for Estimation of Time Delay,” IEEE Trans. on Acoustics, Speech, and Signal Processing, vol. ASSP-24, no. 4, pp.320-327, 1976

### SUMMARY OF INVENTION

In encoding of a stereo signal, there is room for consideration regarding a method of estimating an inter-channel time difference (ITD).

One non-limiting and exemplary embodiment facilitates providing an inter-channel time difference estimation apparatus and an inter-channel time difference estimation method each capable of improving ITD estimation performance in encoding of a stereo signal.

An inter-channel time difference estimation apparatus according to an embodiment of the present disclosure includes: a first converter, which in operation, converts a left (L) channel signal and a right (R) channel signal in a time domain constituting a stereo signal into an L channel spectrum signal and an R channel spectrum signal in a frequency domain, respectively; a calculator, which in operation, calculates a cross power spectrum from the L channel spectrum signal and the R channel spectrum signal; a second converter, which in operation, converts the cross power spectrum into an inter-channel cross correlation function in the time domain; a time domain weighter, which in operation, performs weighting on the inter-channel cross correlation function in accordance with an inter-channel level difference (ILD) value for the stereo signal; and an estimator, which in operation, estimates an inter-channel time difference (ITD) value for the stereo signal based on the inter-channel cross correlation function after the weighting.

It should be noted that general or specific embodiments may be implemented as a system, an apparatus, a method, an integrated circuit, a computer program, a storage medium, or any selective combination thereof.

According to an embodiment of the present disclosure, it is possible to improve ITD estimation performance in encoding of a stereo signal.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a block diagram illustrating an exemplary configuration of an encoding apparatus for a speech/audio signal;

FIG. 2 is a block diagram illustrating an exemplary configuration of a decoding apparatus for a speech/audio signal;

FIG. 3 is a block diagram illustrating an exemplary configuration of an ITD analyzer; and

FIG. 4 is a block diagram illustrating another exemplary configuration of the ITD analyzer.

### DESCRIPTION OF EMBODIMENTS

Hereinafter, embodiments of the present disclosure will be described in detail with reference to the accompanying drawings.

One of encoding methods for a stereo signal is a method of parameterizing a stereo signal by an inter-channel time difference (ITD) for the stereo signal including a left channel (L channel or L-ch) and a right channel (R channel or R-ch).

The inter-channel time difference (ITD) of a stereo signal is a parameter related to the time difference between the arrival of sound between the L channel and the R channel. For example, in estimation (or detection) of the ITD, a cross-spectrum (also referred to as a cross-power spectrum) is calculated based on fast Fourier transform (FFT) spectra of a pair of channel signals included in a stereo signal. Then, the ITD is estimated based on a time lag with respect to a peak position of inter-channel cross correlation (ICC) in a time domain obtained by performing inverse fast Fourier transform (IFFT) on the cross-spectrum.

One method for estimating the ITD is a generalized cross-correlation phase transform (GCC-PHAT) method (see, for example, NPL 1). Note that the GCC-PHAT method is also referred to as a cross-power spectrum phase analysis (CSP) method.

In the GCC-PHAT method, for example, the cross-spectrum calculated from the FFT spectra of a pair of channel signals included in a stereo signal is weighted by the reciprocal of the amplitude of the cross-spectrum. Then, in the GCC-PHAT method, the ITD is estimated based on the time lag with respect to the peak position of the inter-channel cross-correlation (ICC) in the time domain obtained by performing IFFT on the weighted cross-spectrum.

The ITD is used, for example, in parametric stereo encoding. Other parameters used in the parametric stereo encoding include an inter-channel level difference (ILD) for a stereo signal. The ILD is a parameter related to a level difference between the L channel and the R channel.

In a case where the ILD is large (for example, in a case where the level difference between the L channel and the R channel is large), it is assumed that a signal of one channel of the channels included in a stereo signal is recorded at a position farther away from the sound source than a signal of the other channel or that there is some obstacle in a path from the sound source to a microphone (one microphone of a stereo microphone composed of two microphones) that records the signal of one channel. In the former case, the ITD is assumed to have some large value other than zero.

In addition, in a case where the ITD is large, the accuracy of phase information (for example, a phase difference) in a high-frequency domain of the cross-spectrum may be low due to a difference in distance from the sound source between the microphones corresponding to the two channels of the stereo signal, thereby possibly deteriorating the ITD estimation performance.

Further, in a case where the L channel signal and the R channel signal include a common signal component (for example, circuit noise) in the ITD estimation by the GCC-PHAT method, this common signal component is emphasized in normalization processing in the GCC-PHAT method, and the ITD estimation performance by the GCC-PHAT method is possibly deteriorated (for example, the ITD may be zero). The deterioration of the ITD estimation performance may cause deterioration of the encoding performance of parametric stereo encoding.

In a non-limiting embodiment of the present disclosure, a method of improving the ITD estimation performance and improving the encoding performance will be described. For example, in a non-limiting embodiment of the present disclosure, in performing the ITD estimation, the weighting for an inter-channel cross correlation function (CCF) in the time domain is adaptively changed (or varied) in accordance with the ILD. This improves the ITD estimation performance in accordance with the ILD.

### Exemplary Configuration of Encoding Apparatus for Speech/Audio Signal

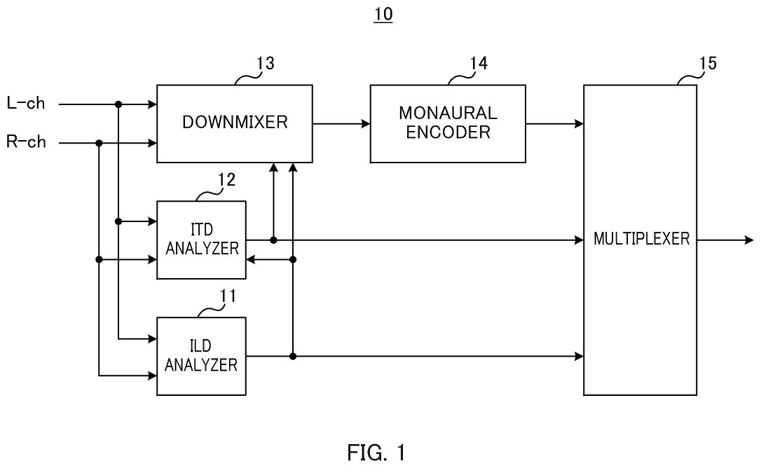

FIG. 1 illustrates an exemplary configuration of an encoding apparatus for a speech signal or an audio signal (for example, referred to as a speech/audio signal) (hereinafter, referred to as an “encoding apparatus”) in a transmission system of a speech/audio signal.

Encoding apparatus 10 illustrated in FIG. 1 may include, for example, ILD analyzer 11, ITD analyzer (for example, corresponding to an inter-channel time difference estimation apparatus) 12, downmixer 13, monaural encoder 14, and multiplexer 15.

ILD analyzer 11 calculates (analyzes, estimates, or detects) an inter-channel level difference (ILD) between an L channel signal (L-ch) and an R channel signal (R-ch) included in an input stereo signal, and encodes the calculated ILD. ILD analyzer 11 outputs an encoding result of the ILD (for example, referred to as an “encoded ILD”) to multiplexer 15, and outputs the calculated ILD (for example, an ILD obtained by decoding the encoded ILD) to ITD analyzer 12 and downmixer 13.

The ILD may be represented as a difference or a ratio between an amplitude of the L channel and an amplitude of the R channel of the stereo signal, for example. For example, the ILD may be defined as ILD=(GL−GR)/(GL+GR). Here, GL and GR indicate the amplitude of the L channel and the amplitude of the R channel, respectively. Note that the method of calculating the ILD is not limited to this method. For example, the ILD may be represented as a difference or a ratio between an amplitude of an L channel spectrum signal and an amplitude of an R channel spectrum signal in a frequency domain.

ITD analyzer 12 calculates (analyzes, or estimates) an inter-channel time difference (ITD) between the L channel signal (L-ch) and the R channel signal (R-ch) included in the input stereo signal based on the ILD inputted from ILD analyzer 11, and encodes the calculated ITD. ITD analyzer 12 outputs an encoding result of the ITD (for example, referred to as an “encoded ITD”) to multiplexer 15, and outputs the calculated ITD (for example, an ITD obtained by decoding the encoded ITD) to downmixer 13. Exemplary processing in ITD analyzer 12 will be described later.

Downmixer 13 performs downmixing processing based on the L channel signal and the R channel signal of the input stereo signal, the ILD inputted from ILD analyzer 11, and the ITD inputted from ITD analyzer 12 to generate a mid (M) channel signal, and outputs the generated M channel signal to monaural encoder 14. For example, downmixer 13 performs the downmixing processing by adding the L channel signal and the R channel signal to generate the M channel signal. In addition, for example, downmixer 13 may adjust a time difference between the L channel signal and the R channel signal (for example, processing to align with no time difference (time lag)) using the ITD. In addition, downmixer 13 may adjust an amplitude difference between the L channel signal and the R channel signal (for example, processing to align with no amplitude difference) using the ILD.

Note that the downmixing processing in downmixer 13 may be performed in the time domain or in the frequency domain. In a case where the downmixing processing is performed in the frequency domain, for example, downmixer 13 performs a time-frequency conversion (for example, FFT) of the L channel signal and the R channel signal, and then adds the spectrum signals of both channels to perform the downmixing processing.

Monaural encoder 14 encodes the M channel signal inputted from downmixer 13, and outputs an encoding result to multiplexer 15.

Multiplexer 15 multiplexes encoding information (for example, referred to as monaural encoding information or an encoded monaural signal) inputted from monaural encoder 14, encoded data (for example, referred to as ILD encoding information or an encoded ILD) inputted from ILD analyzer 11, and encoded data (for example, referred to as ITD encoding information or an encoded ITD) inputted from ITD analyzer 12, and transmits the multiplexed encoding information (for example, referred to as encoded data) to decoding apparatus 20 via a communication network or a storage medium (not illustrated).

Note that, for example, encoding apparatus 10 may generate a side(S) channel signal in addition to the M channel signal in downmixer 13, and encode the M channel signal and the S channel signal (not illustrated). The S channel signal may be calculated as a difference signal between both channels. In addition, the calculation of the S channel signal may include processing of adjusting a time difference between both channels using the ITD (for example, processing to align with no time lag) and/or processing of adjusting an amplitude difference between both channels using the ILD (for example, processing to align with no amplitude difference). In a case where the S channel signal is also encoded in encoding apparatus 10, multiplexer 15 may multiplex encoding information of the S channel signal with the other encoding information.

### Exemplary Configuration of Decoding Apparatus

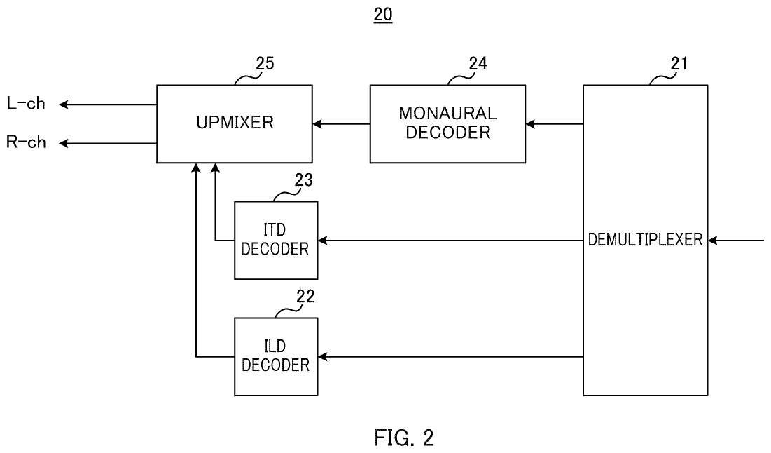

FIG. 2 illustrates an exemplary configuration of a decoding apparatus for a speech/audio signal (hereinafter, referred to as a “decoding apparatus”) in the transmission system of a speech/audio signal.

Decoding apparatus 20 illustrated in FIG. 2 may include, for example, demultiplexer (or separator) 21, ILD decoder 22, ITD decoder 23, monaural decoder 24, and upmixer 25.

For example, demultiplexer 21 receives the encoded data generated in encoding apparatus 10 via the communication network or the storage medium (not illustrated), separates the multiplexed encoding information from the encoded data, and outputs the encoded ILD to ILD decoder 22, the encoded ITD to ITD decoder 23, and the monaural encoding information to monaural decoder 24.

ILD decoder 22 decodes the encoded ILD inputted from demultiplexer 21, and outputs the decoded ILD (hereinafter, referred to as a decoded ILD or an estimated ILD) to upmixer 25.

ITD decoder 23 decodes the encoded ITD inputted from demultiplexer 21, and outputs the decoded ITD (hereinafter, referred to as a decoded ITD or an estimated ITD) to upmixer 25.

Monaural decoder 24 decodes the monaural encoding information inputted from demultiplexer 21, and outputs the decoded monaural signal to upmixer 25.

Upmixer 25 performs upmixing processing based on the decoded ILD inputted from ILD decoder 22, the decoded ITD inputted from ITD decoder 23, and the decoded monaural signal inputted from monaural decoder 24, and outputs a decoded stereo signal (for example, including a decoded L channel signal and a decoded R channel signal). For example, upmixer 25 may upmix the decoded monaural signal to the decoded stereo signal having the amplitude difference expressed by the decoded ILD and the time difference expressed by the decoded ITD.

Note that, in a case where the S channel signal (for example, the encoded S channel signal) is also multiplexed as the encoded data, decoding apparatus 20 may output the encoded S channel signal to an S channel signal decoder (not illustrated). For example, the S channel signal decoder decodes the encoded S channel signal, and outputs the decoded S channel signal to upmixer 25. Then, upmixer 25 performs the upmixing processing using the decoded S channel signal. For example, the downmixing from the L/R channel signal to the M/S channel signal is represented by M=0.5×(L+R) and S=0.5×(L−R), and the upmixing from the M/S channel signal to the L/R channel signal is represented by L=M+S and R=M−S. Note that L and R, and M and S may be exchanged in the above expressions.

### Exemplary Configuration of ITD Analyzer

Next, an exemplary configuration and an exemplary operation of ITD analyzer 12 will be described.

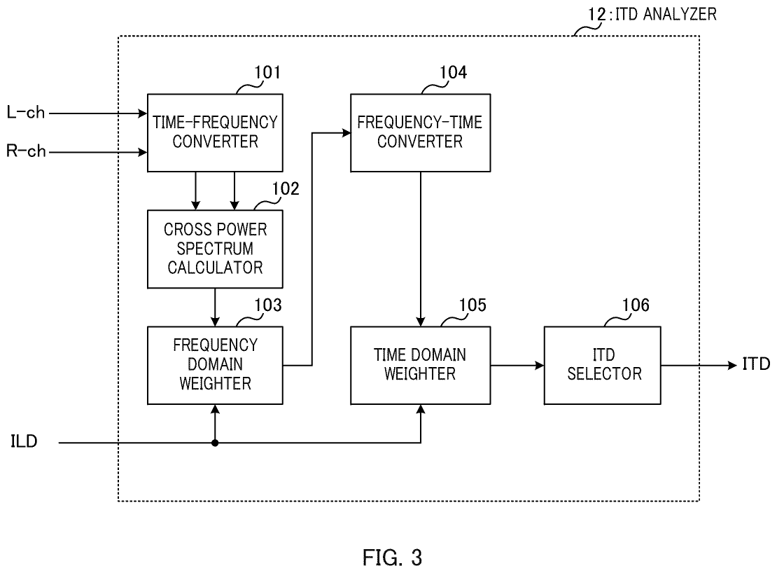

FIG. 3 illustrates an exemplary internal configuration of ITD analyzer 12. ITD analyzer 12 illustrated in FIG. 3 includes time-frequency converter 101, cross power spectrum (cross correlation spectrum (CCS)) calculator 102, frequency domain weighter 103, frequency-time converter 104, time domain weighter 105, and ITD selector 106.

Time-frequency converter 101 performs time-frequency conversion processing such as fast Fourier transform (FFT) on an L channel signal and an R channel signal composing an input stereo signal, and converts the signals into spectrum signals of both channels (for example, an L channel spectrum signal and an R channel spectrum signal). Time-frequency converter 101 outputs the spectrum signals of both channels to cross power spectrum calculator 102. Note that the time-frequency conversion processing is not limited to FFT, and other conversion processing may be used.

Cross power spectrum calculator 102 calculates a cross power spectrum from the spectrum signals of both channels inputted from time-frequency converter 101, and outputs the calculated cross power spectrum to frequency domain weighter 103. The cross power spectrum is described as, for example, a “cross correlation spectrum” in PTL 2, and a method of calculating the cross correlation spectrum is described in PTL 2.

The decoded ILD is inputted to frequency domain weighter 103 from ILD analyzer 11 illustrated in FIG. 1, and the cross power spectrum is inputted to frequency domain weighter 103 from cross power spectrum calculator 102. Frequency domain weighter 103 performs weighting (for example, referred to as frequency domain weighting) on the cross power spectrum (CCS) in accordance with the decoded ILD. For example, frequency domain weighter 103 performs the frequency domain weighting defined based on the decoded ILD on the cross power spectrum, and outputs the weighted cross power spectrum to frequency-time converter 104.

In the frequency domain weighting based on the ILD, for example, as the ILD value is larger (for example, as the amplitude difference between the channels is larger), a weighting factor in a band (for example, near 50 Hz to 1500 Hz) that is important for localization in terms of human auditory perception may be set to be larger, and a weighting factor in a band other than the band that is important for localization may be set to be smaller. For example, in the frequency weighting based on the ILD, the further away from the band that is important for localization, the smaller the weighting factor may be set.

For example, the frequency domain weighting based on the ILD may be 1/pow(f, x). Here, pow(f, x) represents x-th power of f, f represents a numerical value (for example, the number of frequency bins) indicating how far the frequency is away from a boundary (for example, 50 Hz or 1500 Hz) of the band that is important for localization, x represents a value corresponding to the ILD, and x is larger as the ILD is larger. For example, in a case where ILD=(GL−GR)/(GL+GR), x may be set to k×ILD. Here, k is a constant and may be set to, for example, 1.0.

In the cross power spectrum, such frequency domain weighting emphasizes a component in the band that is important for localization in terms of human auditory perception, and reduces (weakens) components in the other bands. As a result, ITD analyzer 12 can appropriately estimate the ITD corresponding to a frequency component that is important for a person to perceive the direction of arrival of sound (for example, a component of a cross-spectrum in a range of 50 Hz to 1500 Hz).

In addition, as described above, in a case where the ILD is large, an accuracy of a phase difference in a high-frequency domain of the cross-spectrum may be low due to a difference in distance from the sound source between the microphones corresponding to two channels of a stereo signal, and the ITD estimation performance may be deteriorated. For this, the frequency domain weighting weakens the component of the cross power spectrum as the frequency domain is further away from the band in which the phase difference is important for localization (for example, 1500 Hz or lower) and as the ILD is larger, thereby preventing the deterioration in the ITD estimation performance due to the phase difference in the high-frequency domain of the cross-spectrum. Meanwhile, as the ILD is smaller, a high-frequency component of the cross-spectrum is less likely to be reduced; accordingly, ITD analyzer 12 can improve the ITD estimation accuracy (for example, sharpness of a peak of the ICC in the time domain) by performing the ITD estimation using the components of the entire frequency band.

Further, for example, in a case where a common signal component (for example, a signal component different from a target of the ITD estimation, such as circuit noise) to the L channel signal and the R channel signal is included in a frequency domain higher than 1500 Hz, and a signal component of the target of the ITD estimation is not included or is included in a small amount, there is a possibility that the ITD is erroneously estimated to be near zero due to the common signal component included in the signal component in the high-frequency domain. For this, the component in the high-frequency domain that is not the band in which the phase difference is important for localization is likely to be reduced by the frequency domain weighting, so that it is possible to prevent the ITD from being erroneously estimated to be near zero even in a case where a signal component different from a signal of the target of the ITD estimation is included in the high-frequency domain. As a result, the ITD estimation performance of ITD analyzer 12 is improved, and the encoding performance of the parametric stereo encoding can be improved.

In addition, for example, in the time-frequency conversion processing (for example, FFT) used to obtain the cross-spectrum, a common analysis window is applied to the signals of both channels, and this may be a signal component common to both channels in a low frequency domain. This common signal component may deteriorate the ITD estimation accuracy as in the case of the high-frequency component described above. For example, a common component caused by an FFT analysis window may appear in an ultra low frequency domain (for example, 50 Hz or lower). For this, the frequency domain weighting reduces a component of the cross-spectrum in the frequency band of 50 Hz or lower, thereby preventing the deterioration in the ITD estimation accuracy due to the characteristics of the FFT analysis window.

Note that the band that is important for localization in terms of human auditory perception is not limited to the range of 50 Hz (for example, corresponding to a first threshold) to 1500 Hz (for example, corresponding to a second threshold), and may be another range.

Frequency-time converter 104 performs frequency-time conversion processing such as inverse fast Fourier transform (IFFT) on the weighted cross power spectrum inputted from frequency domain weighter 103, and outputs a cross correlation function (CCF) in the time domain to time domain weighter 105. Note that the frequency-time conversion processing is not limited to IFFT, and other conversion processing may be used.

The decoded ILD is inputted to time domain weighter 105 from ILD analyzer 11 illustrated in FIG. 1, and the cross correlation function is inputted to time domain weighter 105 from frequency-time converter 104. Time domain weighter 105 performs weighting (for example, referred to as time domain weighting) on the cross correlation function (CCF) in accordance with the decoded ILD. For example, time domain weighter 105 performs time domain weighting defined based on the decoded ILD on the cross correlation function in the time domain, and outputs the weighted cross correlation function to ITD selector 106.

In the time domain weighting based on the ILD, for example, as the ILD is larger, a weighting factor for a component of a time slot closer to the center time of the cross correlation function (time at which ITD=0 in the cross correlation function) may be set to be smaller.

For example, in a case where ILD=(GL−GR)/(GL+GR), the time domain weighting based on the ILD may be (1−ILD)+s×|t−T0|, −ILD/s<t<ILD/s. Here, t represents time, T0 represents the time corresponding to ITD=0 (time point at which the ITD is zero), and s represents an amount of a weight that changes in a unit time (sampling interval) with a step width of the weight. For example, s may be set to 0.1. In this case, the weighting factor is set to be small in a range of ±ILD/s samples before and after ITD=0 (for example, a time slot larger than −ILD/2 and smaller than ILD/s with ITD=0 as the center), and the weighting factor is set to be the smallest (for example, 1−ILD) at the time of ITD=0.

In general, for a signal inputted from a normal stereo microphone, the ITD is highly likely to take a value away from zero (for example, some large value that is not zero) as the ILD is larger. The time domain weighting reduces (weakens) a component of a time slot closer to ITD=0 as the ILD is larger; accordingly, it is possible to avoid erroneous detection of the ITD near ITD=0 in ITD selector 106 described below in a case where the ILD is large (for example, in a case where the ITD is likely to be some large value other than zero).

ITD selector 106 extracts a peak position based on the weighted cross correlation function inputted from time domain weighter 105, and selects (or estimates) the ITD corresponding to the extracted peak position. ITD selector 106 outputs the estimated ITD. For example, a method disclosed as peak picking in PTL 2 may be applied as a method of extracting the peak position.

Note that, in ITD analyzer 12, either one of frequency domain weighter 103 or time domain weighter 105 may be operated, or both of them may be operated.

In addition, a specific weighting method (for example, a weighting function) of the frequency domain weighting and the time domain weighting is not limited to the above-described method, and may be a method defined so that the band is limited to a band that is important for localization in terms of auditory perception as the ILD is larger, or a method defined so that the cross correlation function in the vicinity of ITD=0 is smaller as the ILD is larger.

Further, the method of calculating the ILD is not limited to (GL−GR)/(GL+GR), and may be, for example, a method based on a ratio or a difference between GL and GR. In this case, a weight definition expression may also be defined (for example, corrected) according to the method of calculating the ILD.

As described above, in the present embodiment, ITD analyzer 12 adaptively performs, in the time domain, the weighting in which a weight of a time slot at and near the time point corresponding to ITD=0 is decreased in accordance with the ILD, as the weighting on the cross correlation function in the ITD estimation. This allows ITD analyzer 12 to appropriately perform the weighting on the cross correlation function in accordance with the ILD value, thereby improving the ITD estimation performance.

In addition, in the present embodiment, ITD analyzer 12 adaptively performs, in the frequency domain, the weighting in which a weight is increased for a frequency component that is important for a person to perceive the direction of arrival of sound and the weight is decreased (attenuated) in accordance with the ILD for the cross-spectrum of the other frequency components. For example, ITD analyzer 12 performs weighting focusing on a low frequency band as the ILD is larger. This allows ITD analyzer 12 to appropriately perform the weighting on the component of the cross power spectrum in accordance with the ILD value, thereby improving the ITD estimation performance.

### Variation

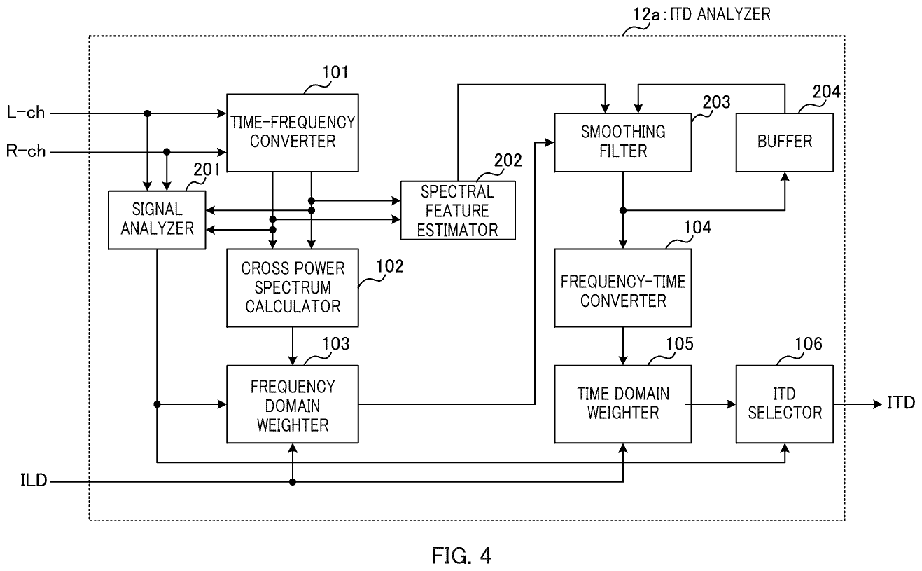

FIG. 4 is a block diagram illustrating an exemplary configuration of ITD analyzer 12a (corresponding to an inter-channel time difference estimation apparatus) in a case where a configuration according to an embodiment of the present disclosure is incorporated into a configuration disclosed in PTL 2 (for example, see FIG. 10a of PTL 2) (but limited to a framework passing through a smoothing filter).

In ITD analyzer 12a illustrated in FIG. 4, signal analyzer 201, spectral feature estimator 202, smoothing filter 203, and buffer 204 are added as compared with FIG. 3.

For example, signal analyzer 201 estimates (or analyzes) a feature of a signal, such as a noise level of each channel signal, based on each inputted channel signal, and outputs information related to the estimated feature to frequency domain weighter 103 and ITD selector 106. For example, frequency domain weighter 103 may control a frequency domain weighting function based on the information inputted from signal analyzer 201. In addition, for example, ITD selector 106 may control the method of extracting the peak of the cross correlation function based on the information inputted from signal analyzer 201.

For example, spectral feature estimator 202 estimates a feature of a spectrum signal, such as spectral flatness measurement (SFM), based on each channel spectrum signal inputted from time-frequency converter 101, and outputs information related to the estimated feature to smoothing filter 203. For example, smoothing filter 203 may adaptively perform smoothing between frames of the cross power spectrum based on the information inputted from spectral feature estimator 202. For example, buffer 204 stores the cross power spectrum of each frame for the smoothing between frames in smoothing filter 203.

The configuration of ITD analyzer 12a illustrated in FIG. 4, for example, also enables appropriate time domain weighting on the cross correlation function in accordance with the ILD value, and improves the ITD estimation performance. In addition, the configuration of ITD analyzer 12a illustrated in FIG. 4, for example, also enables appropriate frequency weighting on the component of the cross power spectrum in accordance with the ILD value, and improves the ITD estimation performance.

The embodiments of the present disclosure have been each described, thus far.

Note that, for a signal inputted from a normal stereo microphone, generally, the larger the ILD is, the more likely the ITD is to be away from zero. On the other hand, the ILD may become large even when the ITD is zero, in a case where there is a difference in sensitivity between microphones corresponding to two channels respectively, or in a case where a stereo signal is created without using microphones. In this case, it is not appropriate to reduce the weight in the area where the ITD is near zero. Therefore, for example, the weighting processing (for example, at least one of the time domain weighting or the frequency domain weighting) in ITD analyzer 12 may be applied in a case where a signal is inputted from a normal stereo microphone and there is no difference in performance between two microphones (for example, in a case where a difference in performance between the microphones can be checked or in a case where a difference in performance between the microphones can be corrected even though there is a difference in performance), and may not be applied in other cases.

Here, the case where a difference in performance between the microphones can be corrected may be, for example, a case where the average amplitude of the output of a microphone for an L-ch and the output of a microphone for an R-ch are observed and the adjustment can be performed by multiplying gain to at least one of the microphones such that the amplitude ratio between the two is 1. Alternatively, the case where a difference in performance between the microphones can be corrected may be, for example, a case where the characteristics of the microphones for both the L-ch and the R-ch can be adjusted and aligned in advance.

Further, in a case where a stereo signal is created without using microphones, any stereo signal can be created, and thus the ILD and the ITD are independent events; accordingly, it is difficult to assume a correlation between the two. Therefore, the weighting of the cross correlation function and the cross-spectrum based on the ILD may not be applied in this case. For example, switching control may be performed so that the above-described weighting is applied in a case where the selected input device is known to be a pair of two microphones in different mounting locations in a terminal equipped with a speech encoding apparatus and the above-described weighting is not applied in a case where another input device (for example, an externally connected microphone to be attached to the terminal) is selected. For example, to determine the switching, ITD analyzer 12 (or encoding apparatus 10) may include a means that acquires information on the selected input device and checks whether the input device is a stereo microphone consisting of a pair of two microphones that are located far apart (e.g., with a distance between the microphones).

For example, ITD analyzer 12 (or encoding apparatus 10) may further include a speech input device information acquirer (not illustrated) that acquires information on a speech input device that acquires an input signal. Time domain weighter 105 may perform the weighting on the inter-channel cross correlation function in accordance with the ILD value described above in a case where the speech input device is a stereo microphone consisting of a pair of two microphones with a distance between the microphones and may not perform the weighting on the inter-channel cross correlation function in accordance with the ILD value described above in a case where the speech input device is not a stereo microphone consisting of a pair of two microphones with a distance between the microphones, based on the information acquired by the speech input device information acquirer.

In addition, for example, ITD analyzer 12 (or encoding apparatus 10) may be provided with an input signal in a format with metadata that includes data indicating information about the recording environment, extract information on the input device during recording from the metadata, check whether the input device is a stereo microphone consisting of a pair of microphones with a distance between the microphones, and then control whether to apply the above-described weighting.

Further, for the operation related to the parts of the above-described configuration that are not specified, for example, an operation based on PTL 2 or other existing stereo encoding methods may be performed.

Although the embodiment has been described above with reference to the drawings, it is needless to say that the present disclosure is not limited to such example. In addition, component elements in the above-mentioned embodiment may be combined as desired.

In the embodiment described above, the term such as “part” or “portion” or the term ending with a suffix such as “-er” “-or” or “-ar” may be replaced with another term, such as “circuit (circuitry),” “assembly,” “device,” “unit,” or “module.”

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, notebook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being less-portable or stationary, such as a smart home device (e.g., an appliance, lighting, smart meter, control panel), a vending machine, and any other “things” in a network of an “Internet of Things (IoT).” The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

An inter-channel time difference estimation apparatus according to an embodiment of the present disclosure includes: a first converter, which in operation, converts a left (L) channel signal and a right (R) channel signal in a time domain constituting a stereo signal into an L channel spectrum signal and an R channel spectrum signal in a frequency domain, respectively; a calculator, which in operation, calculates a cross power spectrum from the L channel spectrum signal and the R channel spectrum signal; a second converter, which in operation, converts the cross power spectrum into an inter-channel cross correlation function in the time domain; a time domain weighter, which in operation, performs weighting on the inter-channel cross correlation function in accordance with an inter-channel level difference (ILD) value for the stereo signal; and an estimator, which in operation, estimates an inter-channel time difference (ITD) value for the stereo signal based on the inter-channel cross correlation function after the weighting.

In the inter-channel time difference estimation apparatus according to an embodiment of the present disclosure, the time domain weighter sets a weighting factor for a component of a time slot closer to a time point at which the ITD value is zero to be smaller in the inter-channel cross correlation function, as the ILD value is larger.

In the inter-channel time difference estimation apparatus according to an embodiment of the present disclosure, the time slot is a time slot that is larger than a first value (−ILD/s) and smaller than a second value (ILD/s) with the time point at which the ITD value is zero as a center, where ILD is the ILD value and s is a sampling interval.

In the inter-channel time difference estimation apparatus according to an embodiment of the present disclosure, a weighting factor applied in the time domain weighter is minimized at a time point at which the ITD value is zero.

The inter-channel time difference estimation apparatus according to an embodiment of the present disclosure further includes a frequency domain weighter, which in operation, performs weighting on the cross power spectrum in accordance with the ILD value.

In the inter-channel time difference estimation apparatus according to an embodiment of the present disclosure, the frequency domain weighter sets a weighting factor in a frequency band equal to or higher than a first threshold and lower than a second threshold to be larger as the ILD value is larger, and sets the weighting factor to be smaller as a frequency is further away from the frequency band.

The inter-channel time difference estimation apparatus according to an embodiment of the present disclosure further includes an acquirer, which in operation, acquires information on a speech input device that acquires an input signal, wherein the time domain weighter performs the weighting on the inter-channel cross correlation function in accordance with the ILD value in a case where the speech input device is a stereo microphone consisting of a pair of two microphones with a distance between the microphones, and does not perform the weighting on the inter-channel cross correlation function in accordance with the ILD value in a case where the speech input device is not the stereo microphone.

In the inter-channel time difference estimation apparatus according to an embodiment of the present disclosure, the ILD value is calculated from an amplitude of the L channel signal and an amplitude of the R channel signal or from an amplitude of the L channel spectrum signal and an amplitude of the R channel spectrum signal.

An encoding apparatus according to an embodiment of the present disclosure includes: the inter-channel time difference estimation apparatus; a downmixer, which in operation, adjusts a time difference between the L channel signal and the R channel signal using the ITD value output from the inter-channel time difference estimation apparatus, and performs downmixing by adding the L channel signal and the R channel signal after adjusting the time difference to generate a mid (M) channel signal; an encoder, which in operation, encodes the M channel signal to generate an encoded monaural signal; and a multiplexer, which in operation, multiplexes the encoded monaural signal and the ITD value.

In the encoding apparatus according to an embodiment of the present disclosure, the downmixer performs downmixing by calculating a difference between the L channel signal and the R channel signal after adjusting the time difference to generate a side(S) channel signal, and the encoder encodes the M channel signal and the S channel signal.

An encoding apparatus according to an embodiment of the present disclosure includes: the inter-channel time difference estimation apparatus; a downmixer, which in operation, adjusts a time difference between the L channel signal and the R channel signal using the ITD value output from the inter-channel time difference estimation apparatus, converts the L channel signal and the R channel signal after adjusting the time difference into the frequency domain, and performs downmixing by adding the L channel spectrum signal and the R channel spectrum signal to generate a mid (M) channel signal; an encoder, which in operation, encodes the M channel signal to generate an encoded monaural signal; and a multiplexer, which in operation, multiplexes the encoded monaural signal and the ITD value.

An inter-channel time difference estimation method according to an embodiment of the present disclosure includes: converting, by an inter-channel time difference estimation apparatus, a left (L) channel signal and a right (R) channel signal in a time domain constituting a stereo signal into an L channel spectrum signal and an R channel spectrum signal in a frequency domain, respectively; calculating, by the inter-channel time difference estimation apparatus, a cross power spectrum from the L channel spectrum signal and the R channel spectrum signal; converting, by the inter-channel time difference estimation apparatus, the cross power spectrum into an inter-channel cross correlation function in the time domain; performing, by the inter-channel time difference estimation apparatus, weighting on the inter-channel cross correlation function in accordance with an inter-channel level difference (ILD) value for the stereo signal; and estimating, by the inter-channel time difference estimation apparatus, an inter-channel time difference (ITD) value for the stereo signal based on the inter-channel cross correlation function after the weighting.

In the inter-channel time difference estimation method according to an embodiment of the present disclosure, a weighting factor for a component of a time slot closer to a time point at which the ITD value is zero is set to be smaller in the inter-channel cross correlation function, as the ILD value is larger.

In the inter-channel time difference estimation method according to an embodiment of the present disclosure, the time slot is a time slot that is larger than a first value (−ILD/s) and smaller than a second value (ILD/s) with the time point at which the ITD value is zero as a center, where ILD is the ILD value and s is a sampling interval.

In the inter-channel time difference estimation method according to an embodiment of the present disclosure, a weighting factor applied in the time domain weighter is minimized at a time point at which the ITD value is zero.

The inter-channel time difference estimation method according to an embodiment of the present disclosure further includes performing, by the inter-channel time difference estimation apparatus, weighting on the cross power spectrum in accordance with the ILD value.

The inter-channel time difference estimation method according to an embodiment of the present disclosure further includes acquiring, by the inter-channel time difference estimation apparatus, information on a speech input device that acquires an input signal, wherein the weighting on the inter-channel cross correlation function in accordance with the ILD value is performed in a case where the speech input device is a stereo microphone consisting of a pair of two microphones with a distance between the microphones, and the weighting on the inter-channel cross correlation function in accordance with the ILD value is not performed in a case where the speech input device is not the stereo microphone.

In the inter-channel time difference estimation method according to an embodiment of the present disclosure, a weighting factor in a frequency band equal to or higher than a first threshold and lower than a second threshold is set to be larger as the ILD value is larger, and the weighting factor is set to be smaller as a frequency is further away from the frequency band.

In the inter-channel time difference estimation method according to an embodiment of the present disclosure, the ILD value is calculated from an amplitude of the L channel signal and an amplitude of the R channel signal or from an amplitude of the L channel spectrum signal and an amplitude of the R channel spectrum signal.

An encoding method according to an embodiment of the present disclosure includes: adjusting, by an encoding apparatus, a time difference between the L channel signal and the R channel signal using the ITD value estimated by the inter-channel time difference estimation method, and performing, by the encoding apparatus, downmixing by adding the L channel signal and the R channel signal after adjusting the time difference to generate a mid (M) channel signal; encoding, by the encoding apparatus, the M channel signal to generate an encoded monaural signal; and multiplexing, by the encoding apparatus, the encoded monaural signal and the ITD value.

The encoding method according to an embodiment of the present disclosure further includes: performing, by the encoding apparatus, downmixing by calculating a difference between the L channel signal and the R channel signal after adjusting the time difference to generate a side(S) channel signal; and encoding, by the encoding apparatus, the M channel signal and the s channel signal.

An encoding method according to an embodiment of the present disclosure includes: adjusting, by an encoding apparatus, a time difference between the L channel signal and the R channel signal using the ITD value estimated by the inter-channel time difference estimation method, converting, by the encoding apparatus, the L channel signal and the R channel signal after adjusting the time difference into the frequency domain, and performing, by the encoding apparatus, downmixing by adding the L channel spectrum signal and the R channel spectrum signal to generate a mid (M) channel signal; encoding, by the encoding apparatus, the M channel signal to generate an encoded monaural signal; and multiplexing, by the encoding apparatus, the encoded monaural signal and the ITD value.

A decoding apparatus according to an embodiment of the present disclosure includes: a separator, which in operation, separates, from encoded data generated by an encoding apparatus, an encoded monaural signal and encoding information of an inter-channel time difference (ITD) value for a stereo signal consisting of a left (L) channel signal and a right (R) channel signal in a time domain; a first decoder, which in operation, decodes the encoding information of the ITD value to obtain a decoded ITD value; a second decoder, which in operation, decodes the encoded monaural signal to obtain a decoded monaural signal; and an upmixer, which in operation, upmixes the decoded monaural signal using the decoded ITD value to obtain a decoded L channel signal and a decoded R channel signal, wherein the encoding apparatus converts the L channel signal and the R channel signal into an L channel spectrum signal and an R channel spectrum signal in a frequency domain, respectively, calculates a cross power spectrum from the L channel spectrum signal and the R channel spectrum signal, converts the cross power spectrum into an inter-channel cross correlation function in the time domain, and performs weighting on the inter-channel cross correlation function in accordance with an inter-channel level difference (ILD) value for the stereo signal, and wherein the ITD value is estimated based on the inter-channel cross correlation function after the weighting.

A decoding method according to an embodiment of the present disclosure includes: separating, by a decoding apparatus, from encoded data generated by an encoding apparatus, an encoded monaural signal and encoding information of an inter-channel time difference (ITD) value for a stereo signal consisting of a left (L) channel signal and a right (R) channel signal in a time domain; decoding, by the decoding apparatus, the encoding information of the ITD value to obtain a decoded ITD value; decoding, by the decoding apparatus, the encoded monaural signal to obtain a decoded monaural signal; and upmixing, by the decoding apparatus, the decoded monaural signal using the decoded ITD value to obtain a decoded L channel signal and a decoded R channel signal, wherein the encoding apparatus converts the L channel signal and the R channel signal into an L channel spectrum signal and an R channel spectrum signal in a frequency domain, respectively, calculates a cross power spectrum from the L channel spectrum signal and the R channel spectrum signal, converts the cross power spectrum into an inter-channel cross correlation function in the time domain, and performs weighting on the inter-channel cross correlation function in accordance with an inter-channel level difference (ILD) value for the stereo signal, and wherein the ITD value is estimated based on the inter-channel cross correlation function after the weighting.

The disclosures of U.S. Provisional Application No. 63/455,287, filed on Mar. 29, 2023 and Japanese Patent Application No. 2023-211347, filed on Dec. 14, 2023, each including the specification, drawings, and abstracts, are incorporated herein by reference in their entirety.

### Industrial Applicability

An exemplary embodiment of the present disclosure is useful for coding systems, etc.

### REFERENCE SIGNS LIST

10 Encoding apparatus
11 ILD analyzer
12, 12a ITD analyzer
13 Downmixer
14 Monaural encoder
15 Multiplexer
20 Decoding apparatus
21 Demultiplexer
22 ILD decoder
23 ITD decoder
24 Monaural decoder
25 Upmixer
101 Time-frequency converter
102 Cross power spectrum calculator
103 Frequency domain weighter
104 Frequency-time converter
105 Time domain weighter
106 ITD selector
201 Signal analyzer
202 Spectral feature estimator
203 Smoothing filter
204 Buffer

1. An inter-channel time difference estimation apparatus comprising:
a first converter, which in operation, converts a left (L) channel signal and a right (R) channel signal in a time domain constituting a stereo signal into an L channel spectrum signal and an R channel spectrum signal in a frequency domain, respectively;
a calculator, which in operation, calculates a cross power spectrum from the L channel spectrum signal and the R channel spectrum signal;
a second converter, which in operation, converts the cross power spectrum into an inter-channel cross correlation function in the time domain;
a time domain weighter, which in operation, performs weighting on the inter-channel cross correlation function in accordance with an inter-channel level difference (ILD) value for the stereo signal; and
an estimator, which in operation, estimates an inter-channel time difference (ITD) value for the stereo signal based on the inter-channel cross correlation function after the weighting.

2. The inter-channel time difference estimation apparatus according to claim 1, wherein,
the time domain weighter sets a weighting factor for a component of a time slot closer to a time point at which the ITD value is zero to be smaller in the inter-channel cross correlation function, as the ILD value is larger.

3. The inter-channel time difference estimation apparatus according to claim 2, wherein,
the time slot is a time slot that is larger than a first value (−ILD/s) and smaller than a second value (ILD/s) with the time point at which the ITD value is zero as a center, where ILD is the ILD value and s is a sampling interval.

4. The inter-channel time difference estimation apparatus according to claim 1, wherein,
a weighting factor applied in the time domain weighter is minimized at a time point at which the ITD value is zero.

5. The inter-channel time difference estimation apparatus according to claim 1, further comprising:
a frequency domain weighter, which in operation, performs weighting on the cross power spectrum in accordance with the ILD value.

6. The inter-channel time difference estimation apparatus according to claim 5, wherein,
the frequency domain weighter sets a weighting factor in a frequency band equal to or higher than a first threshold and lower than a second threshold to be larger as the ILD value is larger, and sets the weighting factor to be smaller as a frequency is further away from the frequency band.

7. The inter-channel time difference estimation apparatus according to claim 1, further comprising:
an acquirer, which in operation, acquires information on a speech input device that acquires an input signal, wherein,
the time domain weighter performs the weighting on the inter-channel cross correlation function in accordance with the ILD value in a case where the speech input device is a stereo microphone consisting of a pair of two microphones with a distance between the microphones, and does not perform the weighting on the inter-channel cross correlation function in accordance with the ILD value in a case where the speech input device is not the stereo microphone.

8. The inter-channel time difference estimation apparatus according to claim 1, wherein,
the ILD value is calculated from an amplitude of the L channel signal and an amplitude of the R channel signal or from an amplitude of the L channel spectrum signal and an amplitude of the R channel spectrum signal.

9. An encoding apparatus comprising:
the inter-channel time difference estimation apparatus according to claim 1;
a downmixer, which in operation, adjusts a time difference between the L channel signal and the R channel signal using the ITD value output from the inter-channel time difference estimation apparatus, and performs downmixing by adding the L channel signal and the R channel signal after adjusting the time difference to generate a mid (M) channel signal;
an encoder, which in operation, encodes the M channel signal to generate an encoded monaural signal; and
a multiplexer, which in operation, multiplexes the encoded monaural signal and the ITD value.

10. The encoding apparatus according to claim 9, wherein,
the downmixer performs downmixing by calculating a difference between the L channel signal and the R channel signal after adjusting the time difference to generate a side (S) channel signal, and
the encoder encodes the M channel signal and the S channel signal.

11. An encoding apparatus comprising:
the inter-channel time difference estimation apparatus according to claim 1;
a downmixer, which in operation, adjusts a time difference between the L channel signal and the R channel signal using the ITD value output from the inter-channel time difference estimation apparatus, converts the L channel signal and the R channel signal after adjusting the time difference into the frequency domain, and performs downmixing by adding the L channel spectrum signal and the R channel spectrum signal to generate a mid (M) channel signal;
an encoder, which in operation, encodes the M channel signal to generate an encoded monaural signal; and
a multiplexer, which in operation, multiplexes the encoded monaural signal and the ITD value.

12. An inter-channel time difference estimation method comprising:
converting, by an inter-channel time difference estimation apparatus, a left (L) channel signal and a right (R) channel signal in a time domain constituting a stereo signal into an L channel spectrum signal and an R channel spectrum signal in a frequency domain, respectively;
calculating, by the inter-channel time difference estimation apparatus, a cross power spectrum from the L channel spectrum signal and the R channel spectrum signal;
converting, by the inter-channel time difference estimation apparatus, the cross power spectrum into an inter-channel cross correlation function in the time domain;
performing, by the inter-channel time difference estimation apparatus, weighting on the inter-channel cross correlation function in accordance with an inter-channel level difference (ILD) value for the stereo signal; and
estimating, by the inter-channel time difference estimation apparatus, an inter-channel time difference (ITD) value for the stereo signal based on the inter-channel cross correlation function after the weighting.

13. The inter-channel time difference estimation method according to claim 12, wherein,
a weighting factor for a component of a time slot closer to a time point at which the ITD value is zero is set to be smaller in the inter-channel cross correlation function, as the ILD value is larger.

14. The inter-channel time difference estimation method according to claim 13, wherein,
the time slot is a time slot that is larger than a first value (−ILD/s) and smaller than a second value (ILD/s) with the time point at which the ITD value is zero as a center, where ILD is the ILD value and s is a sampling interval.

15. The inter-channel time difference estimation method according to claim 12, wherein,
a weighting factor applied in the time domain weighter is minimized at a time point at which the ITD value is zero.

16. The inter-channel time difference estimation method according to claim 12, further comprising:
performing, by the inter-channel time difference estimation apparatus, weighting on the cross power spectrum in accordance with the ILD value.

17. The inter-channel time difference estimation method according to claim 16, wherein,
a weighting factor in a frequency band equal to or higher than a first threshold and lower than a second threshold is set to be larger as the ILD value is larger, and the weighting factor is set to be smaller as a frequency is further away from the frequency band.

18. The inter-channel time difference estimation method according to claim 12, further comprising:
acquiring, by the inter-channel time difference estimation apparatus, information on a speech input device that acquires an input signal, wherein,
the weighting on the inter-channel cross correlation function in accordance with the ILD value is performed in a case where the speech input device is a stereo microphone consisting of a pair of two microphones with a distance between the microphones, and the weighting on the inter-channel cross correlation function in accordance with the ILD value is not performed in a case where the speech input device is not the stereo microphone.

19. The inter-channel time difference estimation method according to claim 12, wherein,
the ILD value is calculated from an amplitude of the L channel signal and an amplitude of the R channel signal or from an amplitude of the L channel spectrum signal and an amplitude of the R channel spectrum signal.

20. An encoding method comprising:
adjusting, by an encoding apparatus, a time difference between the L channel signal and the R channel signal using the ITD value estimated by the inter-channel time difference estimation method according to claim 12, and performing, by the encoding apparatus, downmixing by adding the L channel signal and the R channel signal after adjusting the time difference to generate a mid (M) channel signal;
encoding, by the encoding apparatus, the M channel signal to generate an encoded monaural signal; and
multiplexing, by the encoding apparatus, the encoded monaural signal and the ITD value.

21. The encoding method according to claim 20, further comprising:
performing, by the encoding apparatus, downmixing by calculating a difference between the L channel signal and the R channel signal after adjusting the time difference to generate a side(S) channel signal; and
encoding, by the encoding apparatus, the M channel signal and the S channel signal.

22. An encoding method comprising:
adjusting, by an encoding apparatus, a time difference between the L channel signal and the R channel signal using the ITD value estimated by the inter-channel time difference estimation method according to claim 12, converting, by the encoding apparatus, the L channel signal and the R channel signal after adjusting the time difference into the frequency domain, and performing, by the encoding apparatus, downmixing by adding the L channel spectrum signal and the R channel spectrum signal to generate a mid (M) channel signal;
encoding, by the encoding apparatus, the M channel signal to generate an encoded monaural signal; and
multiplexing, by the encoding apparatus, the encoded monaural signal and the ITD value.
